(19) United States
(12) Patent Application Publication
(10) Pub. No.: US 2026/0086494 A1
(43) Pub. Date: Mar. 26, 2026

(54) MONOCHROME PRINTER AND IMAGE FORMING APPARATUS

(71) Applicant: CANON KABUSHIKI KAISHA, Tokyo (JP)

(72) Inventors: KOJI MIWA, Shizuoka (JP); YOJI MISAO, Shizuoka (JP); CHIKARA IMAIZUMI, Shizuoka (JP); SHUICHI GOFUKU, Shizuoka (JP)

(21) Appl. No.: 19/340,264

(22) Filed: Sep. 25, 2025

(30) Foreign Application Priority Data
Sep. 26, 2024 (JP) 2024-167104
Feb. 3, 2025 (JP) 2025-016335
Jun. 27, 2025 (JP) 2025-109682

(51) Int. Cl. G03G 21/16; G03G 15/00; G03G 15/16; G03G 21/20

(52) U.S. Cl. CPC G03G 21/1633; G03G 15/1605; G03G 15/5016; G03G 15/751; G03G 21/1647; G03G 21/206; G03G 2221/1654

(57) ABSTRACT

An image forming apparatus to which a cartridge is to be removably mounted includes an apparatus main body and a tray movable between a housed position in which the tray is housed in the apparatus and a pulled-out position in which the tray is pulled out from the apparatus. The tray includes a frame having an opening and a cover fixed to the frame, the cover covers the opening so that a part of the opening forms a mounting portion in which the cartridge is contained. When a region of the opening covered with the cover is defined as a covered region, the covered region is larger than the mounting portion as viewed in a direction in which the cartridge is mounted to the tray.

### BACKGROUND

### Field of the Technology

The present disclosure relates to a monochrome printer and an image forming apparatus.

### Description of the Related Art

Some image forming apparatuses, such as printers, copiers, and multifunction devices, have a tray that moves between the inside and outside of the apparatus main body, and allow a cartridge to be removably mounted on the tray. Japanese Patent Application Laid-Open No. 2010-244018 proposes an image forming apparatus that has a tray movable to the outside of the main body of the image forming apparatus through an opening and allows the cartridge to be removed and replaced when the tray is pulled out of the apparatus. Japanese Patent Application Laid-Open No. 2014-232130 proposes a configuration in which full-color image formation is performed using a plurality of image forming unites and monochrome image formation is performed by removing the image forming units other than the black image forming unit from the plurality of image forming units.

In an image forming apparatus having a tray that moves between the inside and outside of the apparatus main body and allowing a cartridge to be mounted to and removed from the tray, usability is reduced if the user has difficulty in recognizing the correct cartridge mounting portion.

### SUMMARY

The present disclosure has been made in view of the above problems, and it is an object of the present disclosure to improve usability in mounting a cartridge in an image forming apparatus having a tray that moves between the inside and outside of an apparatus main body and allowing the cartridge to be mounted to and removed from the tray.

The present disclosure provides a monochrome printer to which a cartridge is to be removably mounted comprising:
an apparatus main body; and
a tray to which the cartridge is to be removably mounted and being movable between a housed position in which the tray is housed in an internal space of the apparatus main body and a pulled-out position in which the tray is pulled out from the apparatus main body, the tray including a frame having an opening and a cover fixed to the frame, wherein
the cover covers a part of the opening,
a region of the opening not covered with the cover forms a mounting portion in which the cartridge is contained, and
in a case that a region of the opening covered with the cover is defined as a covered region, the covered region is larger than the mounting portion when viewed in a direction in which the cartridge is mounted to the tray.

The present disclosure also provides an image forming apparatus to which a cartridge is to be removably mounted comprising:
an apparatus main body; and
a tray to which the cartridge is to be removably mounted and being movable between a housed position in which the tray is housed in an internal space of the apparatus main body and a pulled-out position in which the tray is pulled out from the apparatus main body, the tray including a frame having an opening and a cover fixed to the frame by screws, wherein
the cover covers a part of the opening,
a region of the opening not covered with the cover forms a mounting portion in which the cartridge is contained,
in a case that a region of the opening covered with the cover is defined as a covered region, the covered region is larger than the mounting portion when viewed in a direction in which the cartridge is mounted to the tray.

The present disclosure also provides a monochrome printer to which a cartridge is to be removably mounted comprising:
an apparatus main body; and
a tray to which the cartridge is to be removably mounted and being movable between a housed position in which the tray is housed in an internal space of the apparatus main body and a pulled-out position in which the tray is pulled out from the apparatus main body, the tray including a frame having an opening and a cover fixed to the frame, wherein
the cover covers a part of the opening,
a part of a region of the opening not covered with the cover forms a mounting portion in which the cartridge is contained, and
in a case that a region of the opening covered with the cover is defined as a covered region and a region obtained by removing the covered region and the mounting portion from the opening is defined as a remaining region when viewed in a direction in which the cartridge is mounted to the tray, when a virtual region having the same shape as the mounting portion is overlapped on the remaining region and the size of an overlapping region between the virtual region and the remaining region is maximized, a part of the virtual region is positioned outside the remaining region.

Features of the present disclosure will become apparent from the following description of embodiments with reference to the attached drawings. The following description of embodiments is described by way of example.

### BRIEF DESCRIPTION OF THE DRAWINGS

FIG. 1 is a view for illustrating the overall configuration of a printer of a first embodiment.

FIG. 2 is a view of the printer according to the first embodiment with the door opened.

FIG. 3 is a view of the printer of the first embodiment in which the fixing apparatus is moved.

FIG. 4 is a view of a state in which the transfer unit and tray unit of the first embodiment are pulled out.

FIG. 5 is a view of the transfer unit of the first embodiment pulled out alone.

FIG. 6 is a view for illustrating the overall configuration of a color printer.

FIG. 7 is a view of a state in which the transfer unit and tray unit of the color printer are pulled out.

FIG. 8A is a perspective view of the transfer unit, tray unit, and cartridge for monochrome printing.

FIG. 8B is a perspective view of the transfer unit, tray unit, cartridge for color printing.

FIG. 9A is a perspective view of the transfer unit and tray unit of a monochrome printer.

FIG. 9B is a perspective view of the transfer unit and tray unit of a color printer.

FIG. 10A is a perspective view of the tray unit of a monochrome printer.

FIG. 10B is a perspective view of the tray unit of a color printer.

FIG. 11A is a top view of the transfer unit, tray unit of the monochrome printer.

FIG. 11B is a top view of the transfer unit and tray unit of the color printer.

FIG. 12A is a top view of the tray unit of a monochrome printer.

FIG. 12B is a top view of the tray unit of a color printer.

FIG. 13A is a perspective view showing airflow near the tray unit of the color printer.

FIG. 13B is a perspective view showing airflow near the tray unit of the monochrome printer.

FIG. 14A is a cross-sectional view of the tray unit of the first embodiment.

FIG. 14B is a cross-sectional view of the tray unit of the first embodiment.

FIGS. 15A and 15B are views of the pressing structures of the tray cover and cartridge of the first embodiment.

FIG. 16 is a perspective view of airflow near the tray unit of a second embodiment.

FIG. 17 is a perspective view of airflow near the tray unit of a third embodiment.

FIG. 18 is a view of a tray cover of a fourth embodiment.

FIG. 19 is a perspective view of the tray unit of the fourth embodiment with a cartridge mounted thereto.

FIG. 20 is a view of a state in which the tray unit of the fourth embodiment is moved to the pulled-out position.

FIG. 21A is a top view of the tray for a monochrome printer according to a modification.

FIG. 21B is a top view of the tray of a monochrome printer according to a modification.

FIG. 21C is a top view of the tray of a monochrome printer according to a modification.

FIG. 21D is a top view of the tray of a monochrome printer according to a modification.

### DESCRIPTION OF THE EMBODIMENTS

Modes for carrying out the present disclosure will now be described in detail by way of illustration on the basis of embodiments in conjunction with the accompanying drawings. However, it should be understood that the dimensions, materials, shapes, and relative arrangement of the components described in the embodiments should be modified as appropriate depending on the configuration of the apparatus to which the disclosure is applied and on various other conditions. In other words, the scope of the present disclosure is not intended to be limited to the embodiments described below.

In the following description, image forming apparatuses such as copiers, printers, facsimile machines, and multifunction devices having a combination of the functions of the above devices are disclosed. In the following description of the embodiments, a printer is presented as an example of the image forming apparatus. The description also discloses a group of image forming apparatuses including a monochrome printer for forming monochrome images and a color printer for forming color images. The monochrome printer and the color printer may share components (parts or members) for purposes such as cost reduction. Note that the monochrome printer and the color printer do not necessarily need to be used in the same place or at the same time. In the following description of embodiments, novel configurations of trays and cartridges for a monochrome printer will be described in comparison with those for a color printer.

### First Embodiment

### Overall Configuration

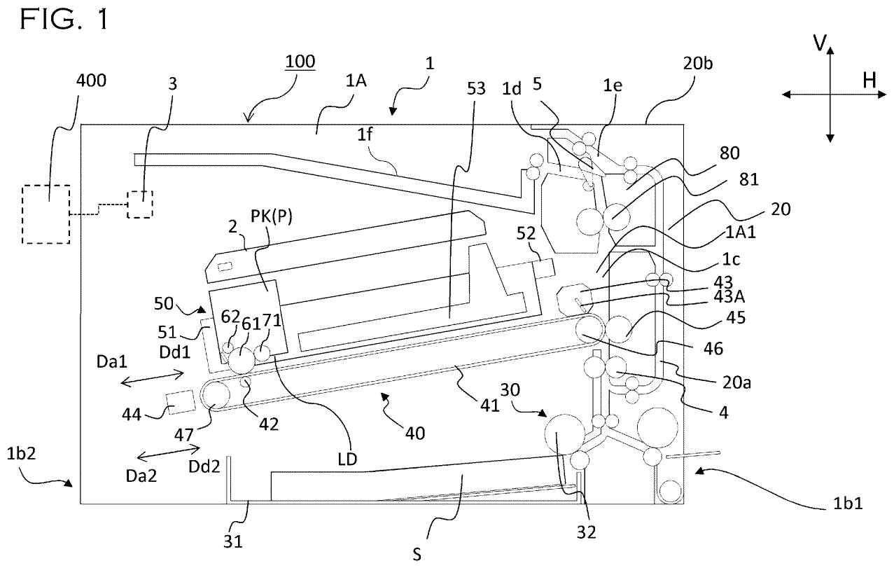

With reference to FIG. 1, the configuration of a printer 1 will be described below. FIG. 1 is a view for illustrating the overall configuration of the printer 1 according to the embodiment. The printer 1 according to the embodiment is a monochrome electrophotographic laser beam printer that forms images on a sheet S which serves as a recording material.

The printer 1 has an apparatus main body 1A (housing), a scanner 2 (exposure device), a control unit 3, and a door 20 (opening/closing member) that can be opened/closed with respect to the apparatus main body 1A. The printer 1 also includes a sheet conveyance unit 30, a transfer unit 40 (transfer device), a tray unit 50 (moving unit, support unit), and a fixing apparatus 80. The portion including the apparatus main body 1A and the door 20 may also be referred to as a main frame 100. The main frame 100 includes an exterior portion of the printer 1.

The apparatus main body 1A accommodates the scanner 2, the control unit 3, the sheet conveyance unit 30, the transfer unit 40, the tray unit 50, and the fixing apparatus 80.

The sheet conveyance unit 30 has a loading tray 31 on which sheets S are loaded and a supply roller 32. The loading tray 31 can be pulled out toward the door 20 to allow replenishment of sheets S.

The tray unit 50 has a tray 51 (support member, drawer) including a tray cover 53. A cartridge PK is removably mounted to the tray 51 and contains black (K) toner (developer).

In the present embodiment, the cartridge PK includes a photosensitive drum 61 (image bearing member), a charging roller 62 (charging member), and a developing roller 71 (developer bearing member). The rotational axis directions of the photosensitive drum 61, the developing roller 71, and the charging roller 62 are parallel to each other. Note that the photosensitive drum 61, the charging roller 62, and the developing roller 71 may be provided on the tray 51 of the tray unit 50, or provided in the cartridge PK. In the present embodiment, the cartridge PK includes the photosensitive drum 61, the charging roller 62, and the developing roller 71.

The transfer unit 40 includes a belt 41, a primary transfer roller 42, a cleaning unit 43, a drive roller 46 for driving the belt 41, a tension roller 47 (driven roller). The printer 1 of the present embodiment is provided with an optical sensor 44 configured to detect a toner image transferred to the belt 41. In the present embodiment, the belt 41 is provided below the photosensitive drum 61 in the direction of gravity V and can be brought into contact with the photosensitive drum 61 such that a primary transfer portion is formed between the belt 41 and the photosensitive drum 61.

The printer 1 also has a secondary transfer roller 45 that is brought into contact with the belt 41 so that a secondary transfer portion is formed. The secondary transfer portion is formed between the belt 41 and the secondary transfer roller 45. The rotational axis directions of the primary transfer roller 42, the drive roller 46, the tension roller 47, and the secondary transfer roller 45 are parallel to each other. A registration roller pair 4 is provided at a position before the secondary transfer portion in the conveyance direction of the sheets S.

The fixing apparatus 80 includes a fixing unit 81 and a flapper 5. When an image forming operation is performed on the sheet S, the fixing apparatus 80 is in a use position. The fixing apparatus 80 is housed inside the apparatus main body 1A in the use position. The fixing apparatus 80 is also configured to heat the sheet S while in the use position. In the present embodiment, the fixing unit 81 includes a heating section (heating roller) including a heating unit and a pressing unit (pressing roller).

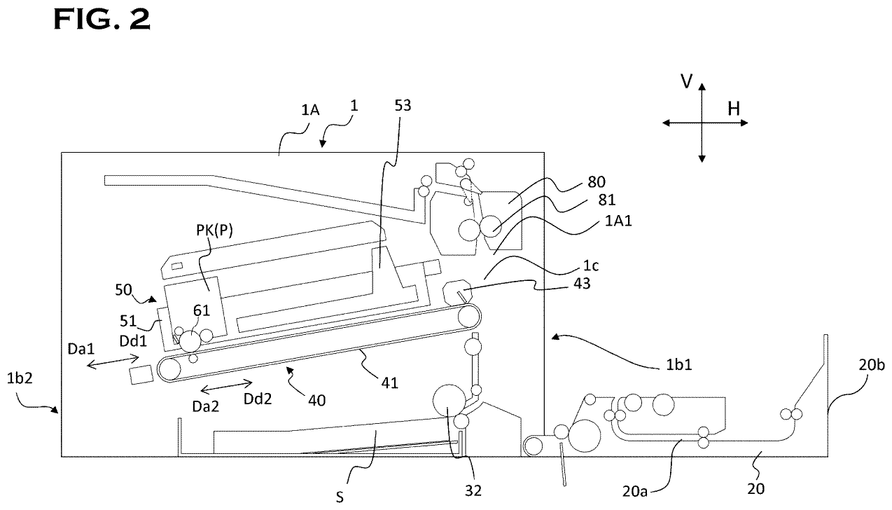

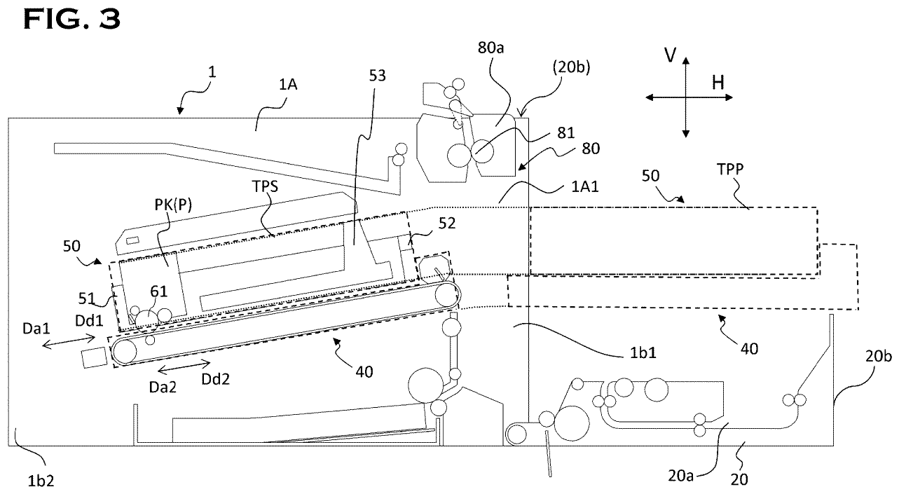

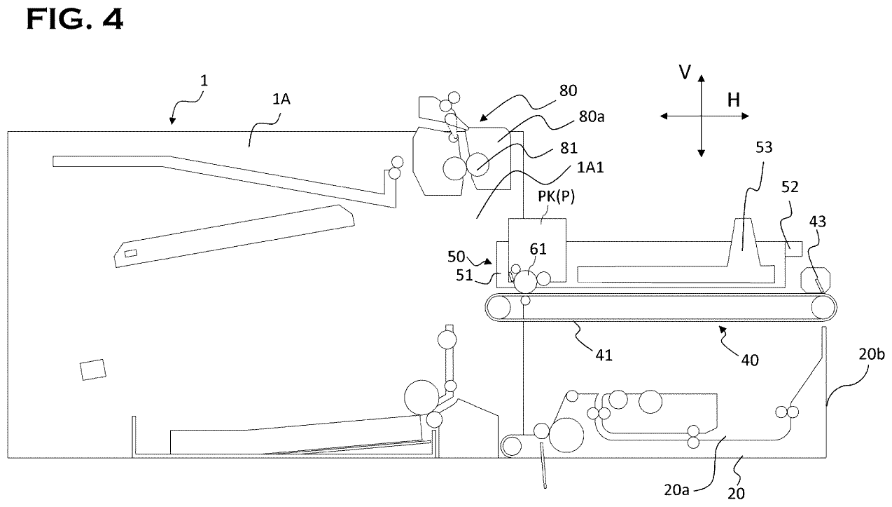

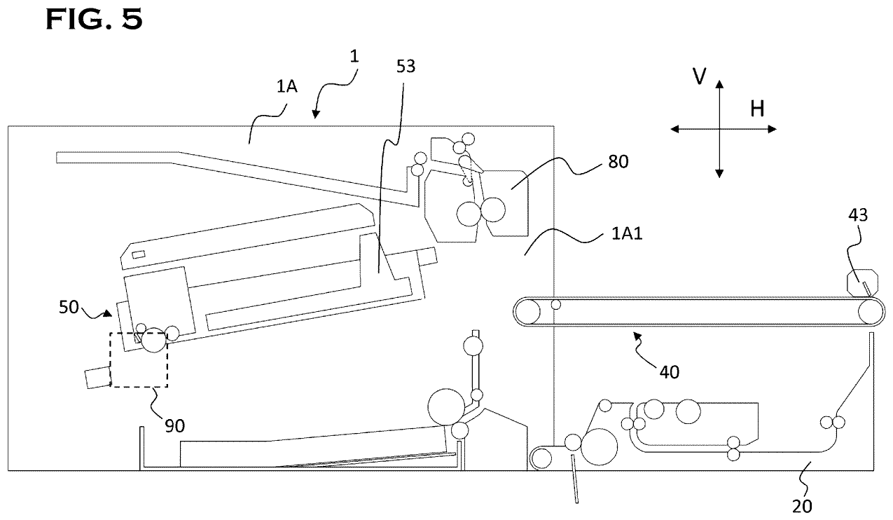

With reference to FIGS. 1 to 5, the movement of the transfer unit 40 and the tray unit 50 will be described. FIG. 2 is a view of the printer 1 with the door 20 opened. FIG. 3 is a view of the printer 1 with the fixing apparatus 80 moved. FIG. 4 is a view of the printer 1 with the transfer unit 40 and the tray unit 50 pulled out. FIG. 5 is a view of the printer 1 with only the transfer unit 40 pulled out.

The transfer unit 40 and the tray unit 50 are movable from the inside to the outside of the apparatus main body 1A. In the horizontal direction H, the apparatus main body 1A has a first end 1b1 provided with an opening 1A1 and a second end 1b2 opposite to the first end 1b1. The tray unit 50 is movable through the opening 1A1 to a first inner position inside the apparatus main body 1A and a first outer position outside the apparatus main body 1A. The transfer unit 40 is movable through the opening 1A1 to a second inner position inside the apparatus main body 1A and a second outer position outside the apparatus main body 1A. The opening 1A1 may include an opening through which the tray unit 50 passes and an opening through which the transfer unit 40 passes. When the transfer unit 40 moves from the second inner position to the second outer position, at least the belt 41 is moved, and at least a part of the belt 41 protrudes to the outside from the apparatus main body 1A.

The direction in which the tray unit 50 is moved from the first inner position to the first outer position will be referred to as a tray removal direction Dd1, and the direction opposite to the tray removal direction Dd1 will be referred to as a tray mounting direction Da1. The tray removal direction Dd1 can be regarded as a direction from the second end 1b2 toward the first end 1b1.

The direction in which the transfer unit 40 is moved from the second inner position to the second outer position will be referred to as a transfer removal direction Dd2, and a direction opposite to the transfer removal direction Dd2 will be referred to as a transfer mounting direction Da2. In the transfer removal direction Dd2, the drive roller 46 is positioned downstream of the tension roller 47. The transfer removal direction Dd2 can be regarded as a direction from the second end 1b2 to the first end 1b1.

The tray removal direction Dd1 and the tray mounting direction Da1 are directions (preferably orthogonal directions) crossing the rotation axis direction of the photosensitive drum 61. The transfer removal direction Dd2 and the transfer mounting direction Da2 are directions (preferably orthogonal directions) crossing the rotational axis direction of the drive roller 46. The direction of the rotational axis of the drive roller 46 is parallel to the direction of the rotational axis of the photosensitive drum 61.

In the horizontal direction H, the fixing apparatus 80 is provided on one end side (the side where the first end 1b1 is provided) of the apparatus main body 1A.

The door 20 attached to the apparatus main body 1A is movable between a closed position and an open position. As shown in FIG. 1, when the door 20 is in the closed position (i.e., in a closed state), the door 20 covers the opening 1A1. As shown in FIG. 2, when the door 20 is in the open position (i.e., in an open state), the opening 1A1 is exposed.

As shown in FIG. 1, when the door 20 is in the closed position, the door 20 covers the fixing apparatus 80 attached to the apparatus main body 1A. More specifically, when the door 20 is in the closed position, the upper cover 20b of the door 20 is located above the fixing apparatus 80. The upper cover 20b of the door 20 serves as part of the exterior.

The door 20 can move between the open position and the closed position while the fixing apparatus 80 is supported by the apparatus main body 1A. In other words, the door 20 moves from the closed position to the open position to move away from the fixing apparatus 80 supported by the apparatus main body 1A. Accordingly, as shown in FIG. 2, when the door 20 is in the open position, the door 20 is apart from the fixing apparatus 80 supported by the apparatus main body 1A.

As will be described, the fixing apparatus 80 is movable from the state shown in FIG. 2 to the state shown in FIG. 3 so that the opening 1A1 is widely exposed. In the state in which both the door 20 and the fixing apparatus 80 are moved (FIG. 3), the transfer unit 40 and the tray unit 50 are movable from the inside to the outside of the apparatus main body 1A through the opening 1A1. After the transfer unit 40 and the tray unit 50 have been moved, the state shown in FIG. 4 is attained.

When the tray unit 50 is moved outside the apparatus main body 1A (see FIG. 4), removal of the cartridge PK from the tray 51 and mounting of the cartridge PK to the tray 51 are allowed. In this way, the cartridge PK can be replaced with a new cartridge PK. In the present embodiment, the cartridge PK is mountable to and removable from the tray 51 in a direction crossing (preferably orthogonal to) the rotational axis of the photosensitive drum 61. The tray unit 50 is movable between a housed position TPS, where the tray unit is housed within the internal space of the apparatus main body 1A as shown in FIG. 3, and a pulled-out position TPP, where the tray unit is pulled out from the apparatus main body 1A as shown in FIG. 4.

The cartridge PK is moved away from the transfer unit 40 with respect to the tray 51 and thus removed from the tray 51. In other words, the cartridge PK is moved to the side opposite to the transfer unit 40 with respect to the tray 51 and removed from the tray 51. In this embodiment, the transfer unit 40 is provided below the tray unit 50. Accordingly, the cartridge PK is moved upward relative to the tray 51 and removed from the tray 51. Since the tray unit 50 and the transfer unit 40 are moved together, the photosensitive drum 61 is prevented from being exposed when the tray unit 50 is moved to the first outer position, and is thus prevented from being damaged or contaminated.

In addition, the transfer unit 40 can be removed from the apparatus main body 1A independently of the tray unit 50 and can be replaced with a new transfer unit 40.

### Image Forming Operation

With reference to FIG. 1, the image forming operation of the printer 1 will be described. The control unit 3 of the printer 1 starts image forming operation on the sheet S in response to an image signal received from an external host apparatus 400. For example, the external host apparatus 400 is a personal computer, an image reader, or a facsimile.

When an image is formed on the sheet S, the fixing apparatus 80 is in the use position, the tray unit 50 is in the first inner position, the transfer unit 40 is in the second inner position, and the door 20 is in the closed position. With the transfer unit 40 in the second inner position, the belt 41 can come into contact with the photosensitive drum 61. At the time, the tray unit 50 is positioned above the transfer unit 40.

A charging voltage is applied to the charging roller 62, and the photosensitive drum 61 is rotated. A laser beam corresponding to the image information is emitted from the scanner 2 onto the photosensitive drum 61, and the surface of the photosensitive drum 61 charged by the charging roller 62 is exposed. As a result, an electrostatic latent image corresponding to the image information is formed on the surface of the photosensitive drum 61.

The developing roller 71 carries toner. A developing voltage is applied to the developing roller 71, and the electrostatic latent image formed on the photosensitive drum 61 is developed by the toner supplied from the developing roller 71, so that a toner image is formed on the surface of the photosensitive drum 61. In the present embodiment, the developing roller 71 develops the electrostatic latent image while in contact with the photosensitive drum 61, but may also develop the electrostatic latent image with a gap present between itself and the photosensitive drum 61.

It is noted that, in the present embodiment, while the tray unit 50 is in the first inner position, the developing roller 71 is movable between a contact position in which it is in contact with the photosensitive drum 61 and a separated position in which it is spaced apart from the photosensitive drum 61. Specifically, a switching device provided in the apparatus main body 1A switches between a state in which the developing roller 71 is in the contact position and a state in which the developing roller 71 is in the separated position. In this way, in the absence of the image forming operation, the developing roller 71 can be kept separated from the photosensitive drum 61.

The toner images formed on the respective photosensitive drums 61 are transferred onto the belt 41 by the primary transfer rollers 42 at the primary transfer portion, and are conveyed toward a secondary transfer portion formed by the belt 41 and the secondary transfer roller 45.

Meanwhile, a conveyance path 1c (first path, first conveyance path) through which the sheet S being conveyed toward the fixing apparatus 80 passes is formed in the apparatus main body 1A. A double-sided conveyance path 20a (second path, second conveyance path) through which the sheet S having passed through the fixing apparatus 80 passes is formed in the door 20. The door 20 covers the conveyance path 1c in a closed state, and when the door 20 is opened, the conveyance path 1c and the double-sided conveyance path 20a are exposed (FIG. 2).

In the sheet conveyance unit 30, one of the sheets S loaded in the loading tray 31 is separated and fed by the supply roller 32 at a predetermined timing and conveyed toward the secondary transfer portion and the fixing apparatus 80 through the conveyance path 1c.

In the secondary transfer portion, the toner image is transferred from the belt 41 onto the sheet S. Toner that has not been transferred onto the sheet S is removed from the belt 41 by a cleaning blade (cleaning member) 43A provided in the cleaning unit 43.

The sheet S with the toner image transferred thereon in the secondary transfer portion is conveyed to the fixing apparatus 80. In the fixing apparatus 80, the sheet S is heated and pressurized by the fixing unit 81, so that the toner image is fixed to the sheet S. The sheet S having the toner image fixed thereon is conveyed toward the flapper 5 which serves as a path switching unit.

The flapper 5 is movable between a discharge position for guiding the sheet S that has passed through the fixing apparatus 80 toward a discharge path 1d, and a reversing position for guiding the sheet S toward a reversing path 1e. In the case of single-sided printing, in which an image is formed on one side of the sheet S, the sheet S is guided by the flapper 5 to the paper discharge path 1d and discharged onto a discharge tray 1f formed in an upper part of the apparatus main body 1A.

Meanwhile, in the case of double-sided printing, in which images are formed on both the front and back sides of the sheet S, the sheet S is guided by the flapper 5 to the reversing path 1e. After being guided to the reversing path 1e, the sheet S has its conveyance direction reversed and is conveyed toward a secondary transfer portion through the double-sided conveyance path 20a formed in the door 20. In the secondary transfer portion, after a toner image is transferred onto the back side of the sheet S, the sheet S passes through the fixing apparatus 80, is guided by the flapper 5 to the paper discharge path 1d, and is discharged onto the discharge tray 1f of the apparatus main body 1A.

### Use of Same Tray for Full-color and Monochrome Printing

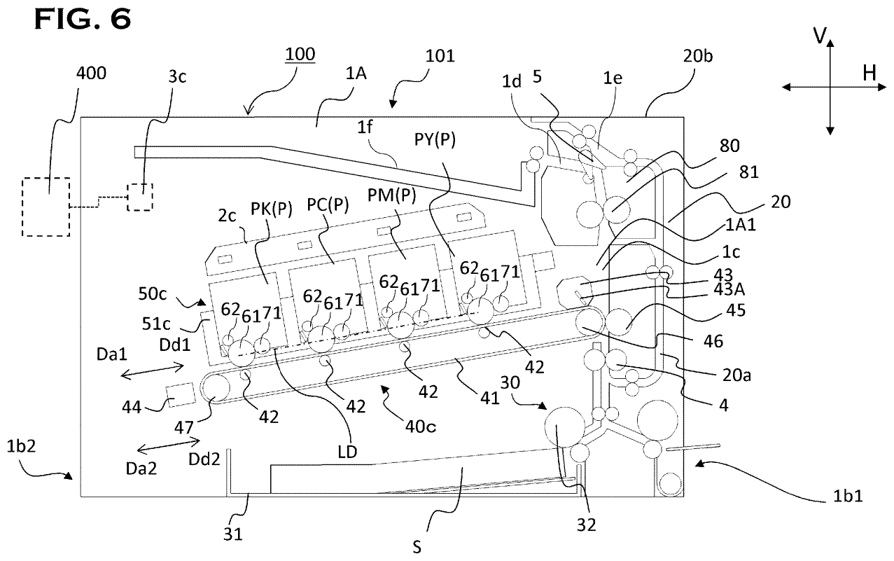

The printer 1 is a monochrome printer in which only one cartridge P can be installed at a time. The housing of the tray 51 of the tray unit 50 of the printer 1 as a monochrome printer has a configuration partly identical to the configuration of the housing of the tray 51c of the tray unit 50c of the color printer 101. As shown in FIG. 6, the tray unit 50c of the color printer 101 is configured to allow four cartridges PY, PM, PC, and PK to be installed in the tray 51c.

The cartridges PY, PM, PC, and PK are removably mounted to the tray 51c independently of one another. The cartridges PY, PM, PC, and PK respectively contain yellow (Y), magenta (M), cyan (C), and black (K) toner (developers). The cartridges PY, PM, PC, and PK have similar configurations except for the difference in the color of the toner they contain. Therefore, in the following description, the configuration and operation of one of the cartridges PY, PM, PC, and PK will be discussed and the other cartridges may not be described. When the cartridges PY, PM, PC, and PK do not need to be distinguished from one another, the cartridges PY, PM, PC, and PK may be simply referred to as a cartridge P. The tray unit 50c may have a plurality of cartridges P and a tray 51c on which the plurality of cartridges P are removably mounted. Toner images of the respective colors are formed on the corresponding photosensitive drums 61 for full-color image formation.

A portion that forms a black (K) image will be referred to as a black station, a portion that forms a cyan (C) image will be referred to as a cyan station, a portion that forms a magenta (M) image will be referred to as a magenta station, and a portion that forms a yellow (Y) image will be referred to as a yellow station. The cartridge PK is mounted on the black station, the cartridge PC is mounted on the cyan station, the cartridge PM is mounted on the magenta station, and the cartridge PY is mounted on the yellow station.

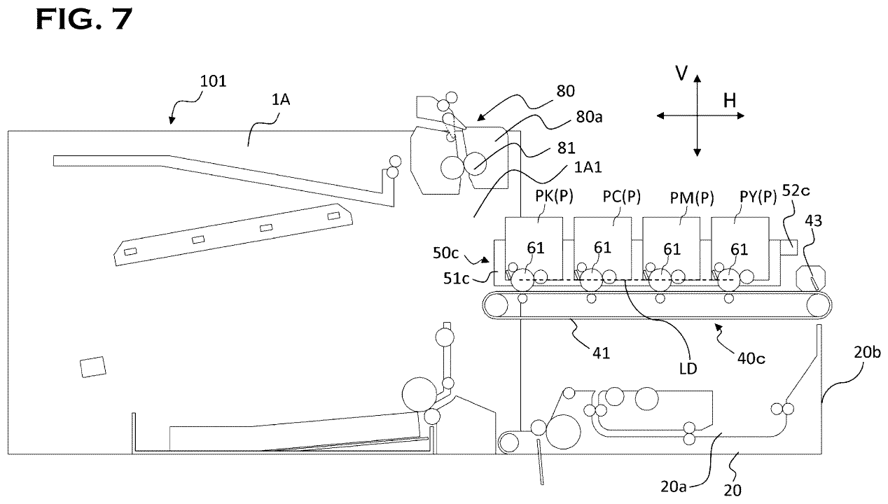

Similarly to the monochrome printer 1, when the tray unit 50c of the color printer 101 is moved to the outside of the apparatus main body 1A (FIG. 7), it is permitted to remove the cartridges PY, PM, PC, and PK from the tray 51c and to mount the cartridges PY, PM, PC, and PK to the tray 51c.

The scanner 2c, the transfer unit 40c, and the control unit 3c have different configurations between the printer 1 which is a monochrome printer and the color printer 101.

### Tray Cover

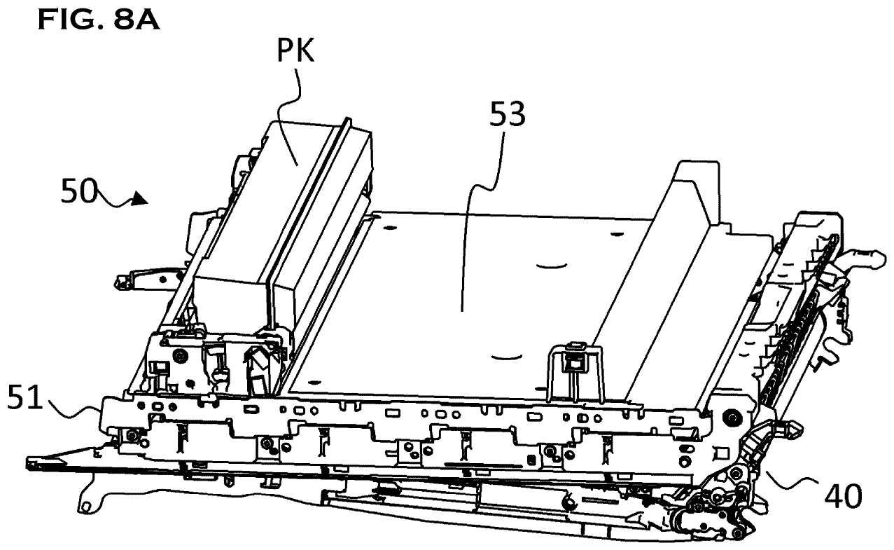

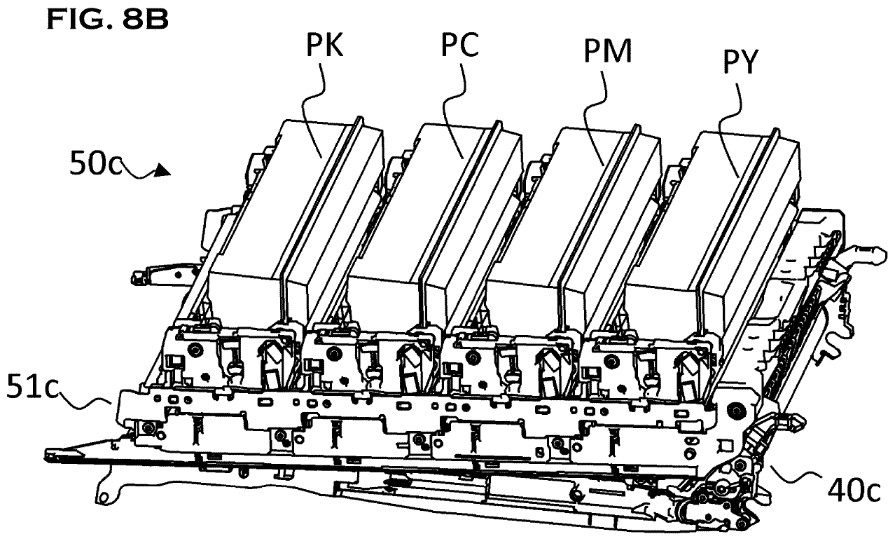

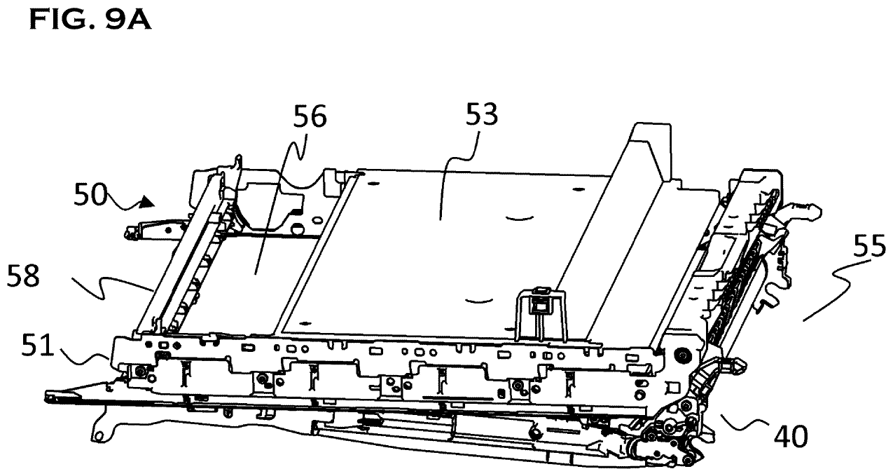

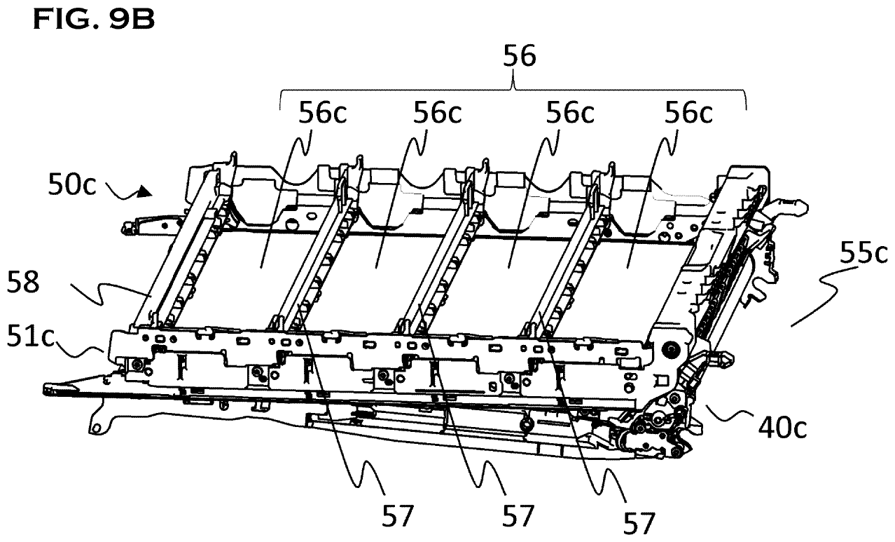

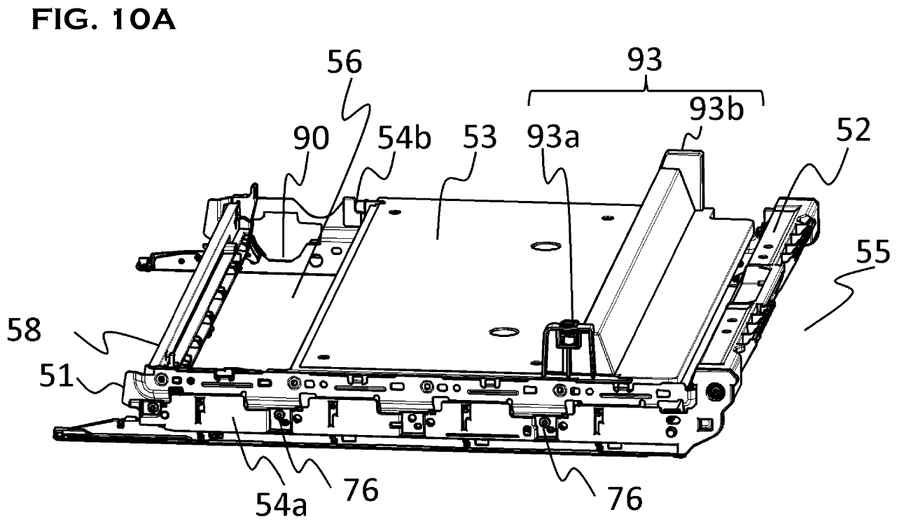

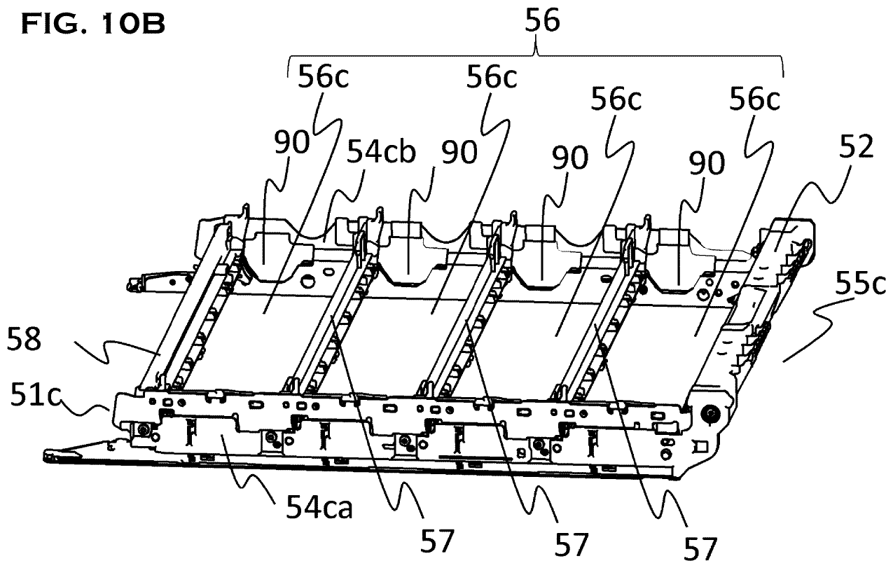

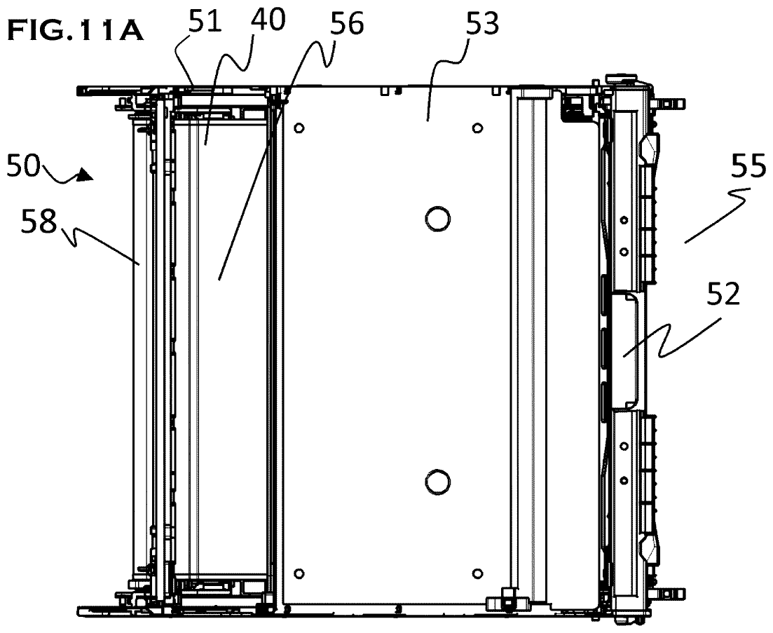

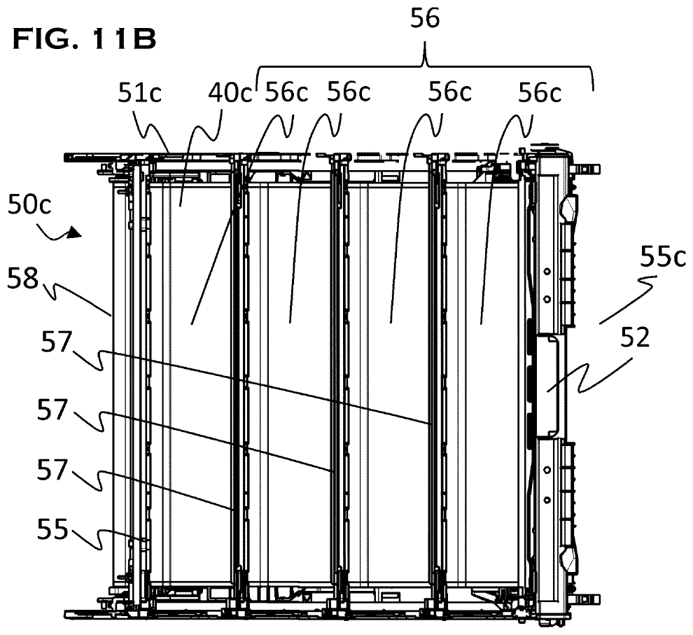

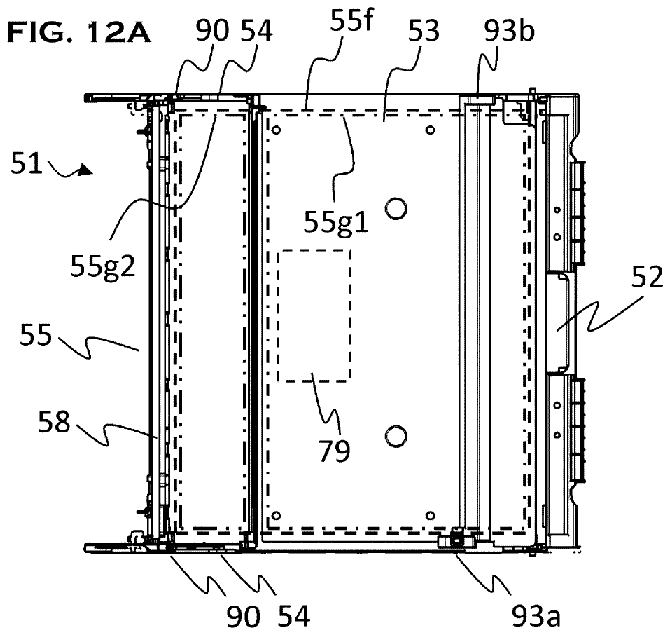

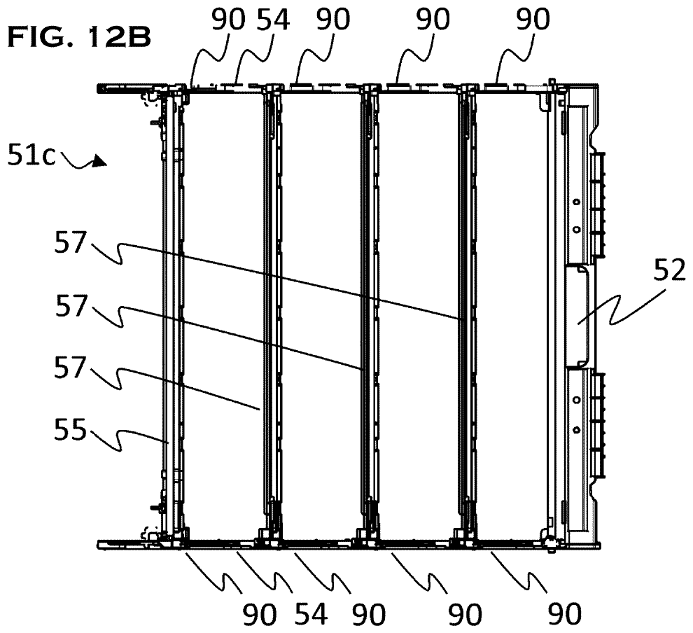

FIGS. 8A to 10B are perspective views of the tray unit. FIGS. 8A and 8B are perspective views of the tray unit 50 and the transfer units (40, 40c) as these units are pulled out together for replacement of the cartridge P. FIGS. 9A and 9B are views of a state with the cartridge P removed. FIGS. 10A and 10B are views of the tray 51 alone. FIGS. 8A, 9A, and 10A are views of the printer 1, which is a monochrome printer. FIGS. 8B, 9B, and 10B are views of the color printer 101. FIGS. 11A and 11B are top views of FIGS. 9A and 9B, respectively, showing the transfer units 40 and 40c in an exposed state. FIGS. 12A and 12B are top views of FIGS. 10A and 10B.

As shown in FIGS. 8A and 8B, the printer 1, which is a monochrome printer, is provided with the cartridge PK, and the color printer 101 is provided with the cartridges PY, PM, PC, and PK.

As shown in FIG. 10B, the tray 51c of the color printer 101 has a tray frame 55c. The tray frame 55c has tray side plates 54c (54ca and 54cb), and a front frame 52 and a rear frame 58 connected to the tray side plates 54ca and 54cb. The front frame 52 may function as a gripping portion that is gripped by a user. The tray side plates 54ca and 54cb are provided at one end and the other end, respectively, of the tray frame 55c in a first direction. The front frame 52 and the rear frame 58 are provided at one end and the other end of the tray frame 55c in a second direction orthogonal to the first direction. Here, the first and second directions are directions crossing the mounting directions of the cartridges PY, PM, PC, and PK to the tray 51c. In the present embodiment, the first direction is parallel to the longitudinal directions of the cartridges PY, PM, PC, and PK, as well as to the rotational axis directions of the photosensitive drums 61 and the developing rollers 71. The second direction is parallel to the moving direction of the tray 51c relative to the apparatus main body 1A when the tray 51c is moved to the housed position TPS and the pulled-out position TPP.

In this embodiment, the tray frame 55c has an opening 56. The opening 56 can be regarded as a space defined by the tray side plates 54ca and 54cb, the front frame 52, and the rear frame 58. That is, the opening 56 is surrounded by the tray side plates 54ca and 54cb, the front frame 52, and the rear frame 58. More specifically, the opening is provided between the tray side plates 54ca and 54cb in the first direction, and between the front frame 52 and the rear frame 58 in the second direction. The opening 56 opens toward the upstream side in the direction in which the cartridge P is mounted to the tray 51c. In this embodiment, the cartridge P is mounted to the tray 51c from above the tray 51c. The opening 56 opens upward. The opening 56 is a through hole formed in the tray frame 55c. More specifically, the opening 56 penetrates the tray frame 55c in the vertical direction.

As shown in FIGS. 10B and 12B, the tray 51c of the color printer 101 includes tray rails 57 for the yellow, cyan, and magenta stations. The opening 56 is partitioned into a plurality of openings 56c by the tray rails 57 (partition members). In this embodiment, the opening 56 is partitioned into four openings 56c by the three tray rails 57. The cartridges PY, PM, PC, and PK are mounted in the respective openings 56c. As shown in FIGS. 9B and 11B, when the cartridges PY, PM, PC, and PK are removed, the transfer unit 40c of the color printer 101 is exposed through the openings 56c.

As shown in FIG. 10A, the tray 51 of the printer 1 has a tray frame 55. The tray frame 55 has tray side plates 54 (54a and 54b), the front frame 52 and the rear frame 58 connected to the tray side plates 54a and 54b. The front frame 52 may function as a gripping portion that is gripped by a user. The tray side plates 54a and 54b are provided at one and the other ends of the tray frame 55 in the first direction. The front frame 52 and the rear frame 58 are provided at one and the other ends of the tray frame 55 in the second direction orthogonal to the first direction. Here, the first and second directions are the same as the first direction and second directions for the tray 51c of the color printer 101.

In the present embodiment, the tray frame 55 has an opening 56. The opening 56 can be regarded as a space partitioned by the tray side plates 54a and 54b, the front frame 52, and the rear frame 58. That is, the opening 56 is surrounded by the tray side plates 54a and 54b, the front frame 52, and the rear frame 58. More specifically, it is provided between the tray side plates 54a and 54b in the first direction and between the front frame 52 and the rear frame 58 in the second direction. The opening 56 opens toward the upstream side in a direction in which the cartridge P is mounted to the tray 51. In the present embodiment, the cartridge PK is mounted to the tray 51 from above the tray 51. The opening 56 opens upward. The opening 56 is a through hole formed in the tray frame 55. More specifically, the opening 56 penetrates the tray frame 55 in the vertical direction.

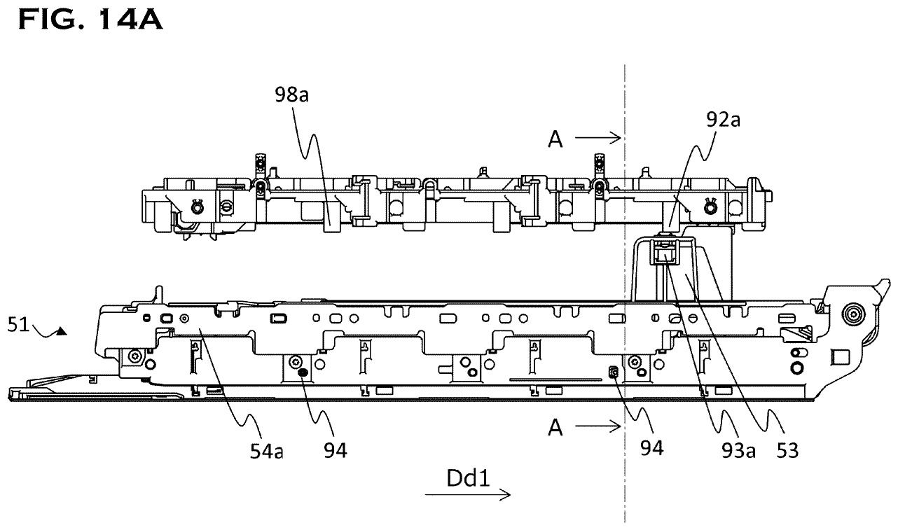

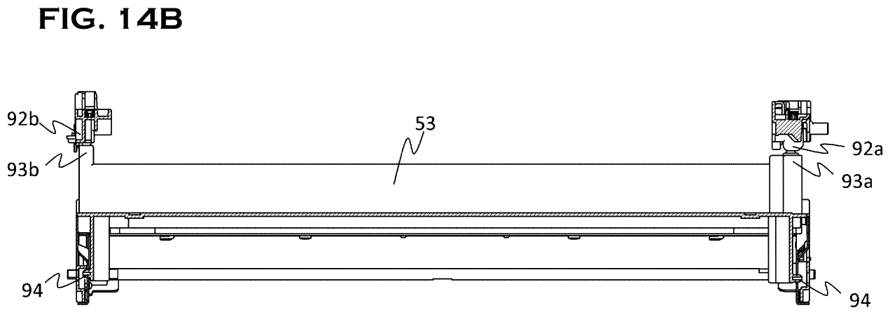

As shown in FIGS. 10A and 12A, the tray 51 of the monochrome printer 1 does not have the tray rail 57 which is provided on the tray 51c of the color printer 101. Meanwhile, the tray 51 has a tray cover 53 that covers a part of the opening 56. In other words, the opening 56 is partly covered with the tray cover 53. The tray cover 53 is fixed to the tray frame 55. More specifically, the movement of the tray cover 53 relative to the tray frame 55 is restricted. In the opening 56, the cartridge PK is mounted in a portion not covered with the tray cover 53. As shown in FIGS. 9A and 11A, in the printer 1, when the cartridge PK is removed, the transfer unit 40 is exposed through the opening 56. The tray cover 53 is fixed to the tray frame 55 by a fastening member 76 (see FIG. 14A). In this embodiment, the fastening member 76 is a screw, but may be a rivet. The tray cover 53 cannot be separated from the tray frame 55 unless the fastening member 76 is removed. The tray cover 53 is fixedly and inseparably attached to the tray frame 55.

The tray cover 53 may be provided at an upper end of the tray frame 55. The region of the opening 56 of the tray 51 of the printer 1 that is covered with the tray cover 53 corresponds to the openings 56c for yellow, cyan, and magenta in the tray 51c of the color printer 101.

In FIG. 12A, the region corresponding to the opening 56 of the tray frame 55, as viewed in the direction in which the cartridge PK is mounted to the tray 51, is indicated by the broken line as a region 55f. The direction in which the cartridge PK is mounted to the tray 51 is the same as the direction in which the cartridge P is mounted to a mounting portion 55g2 which will be described later. The tray side plates 54a and 54b are formed as first and second side walls of the frame, the rear frame 58 located on the back side when viewed from the user is formed as a first connection part of the frame, and the front frame 52 gripped by the user is formed as a second connection part of the frame. At this time, the first and second side walls face each other in the opposing direction, and the region 55f (opening 56) is located between the first and second side walls and between the first and second connection portions. The opposing direction is the same as the first direction.

In the region 55f, the region covered with the tray cover 53 is a covered region 55g1 and indicated by the dash-dot line. Meanwhile, a region not covered with the tray cover 53 in the region 55f is the mounting portion 55g2 and shown by the dash-double-dot line. A cartridge P is removably mounted into the mounting portion 55g2. That is, the cartridge P is contained in the mounting portion 55g2. When viewed in the direction in which the cartridge P is mounted to the mounting portion 55g2, the mounting portion 55g2 is positioned between the tray cover 53 and the rear frame 58. The tray cover 53 is located on the downstream side of the mounting portion 55g2 in the tray removal direction Dd1.

When viewed in a direction in which the cartridge P is mounted to the mounting portion 55g2, the covered region 55g1 is larger than the mounting portion 55g2. More preferably, the size of the covered region 55g1 is at least twice the size of the mounting portion 55g2 when viewed in the direction of mounting the cartridge P to the mounting portion 55g2. With such a configuration, the area of the covered region 55g1 in the monochrome printer 1 can be made to correspond to at least a part of the area of the color mounting portions to which the color cartridges PC, PM, and PY are mounted in the color printer 101. For example, when the size of the covered region 55g1 is twice the size of the mounting portion 55g2, the area of two cartridges for color can be covered. Furthermore, if the size of the covered region 55g1 is set to be three times the size of the mounting portion 55g2, a region corresponding to the entire area of the color mounting portions can be covered. The tray cover 53 reduces an area where the opening 56 is exposed. Accordingly, the user can easily identify the mounting portion of the cartridge PK.

In the monochrome printer 1, when replacing the cartridge PK, the cartridge PK is mounted in the rearmost slot (the most upstream side in the tray removal direction Dd1) with the door 20 opened and the tray unit 50 fully pulled out to the front. Here, because the tray cover 53 is provided as in the present embodiment, only one opening 56 is provided to allow the cartridge PK to be inserted therein, it is possible to prevent the cartridge PK from being accidentally inserted into another mounting portion. Furthermore, it is also possible to prevent an article from accidentally falling onto the belt 41 of the transfer unit 40 when replacing the cartridge PK.

It is also preferable to provide a display 79 on the upper surface of the tray cover 53 for displaying information related to the mounting of the cartridge PK. This makes it possible to clearly show the mounting position of the cartridge PK to the user without viewing the operation panel or instructions. Also, the tray cover 53 may function as a guide member for guiding the cartridge PK to be mounted to the mounting portion 55g2. Also, the tray cover 53 may function as a positioning portion that restricts movement of the cartridge PK mounted to the mounting portion 55g2.

### Airflow

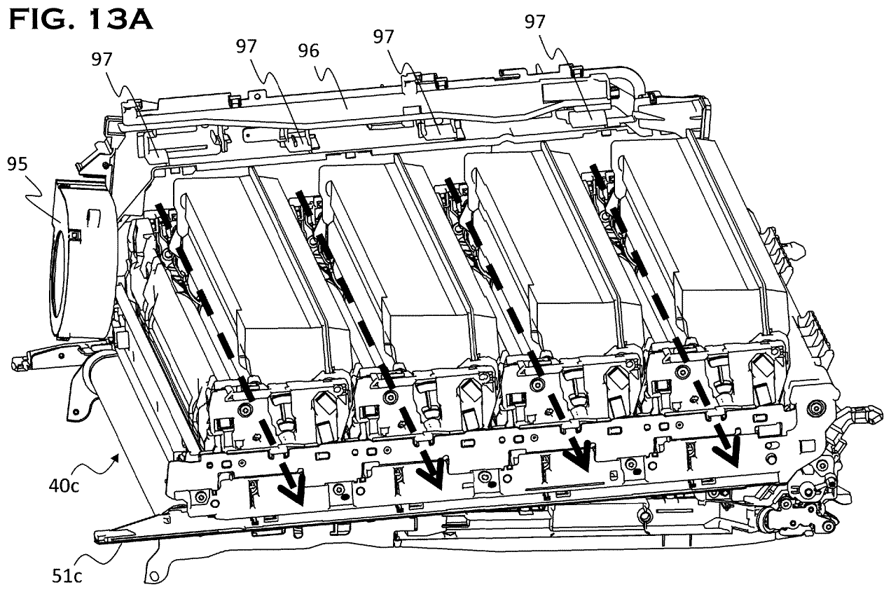

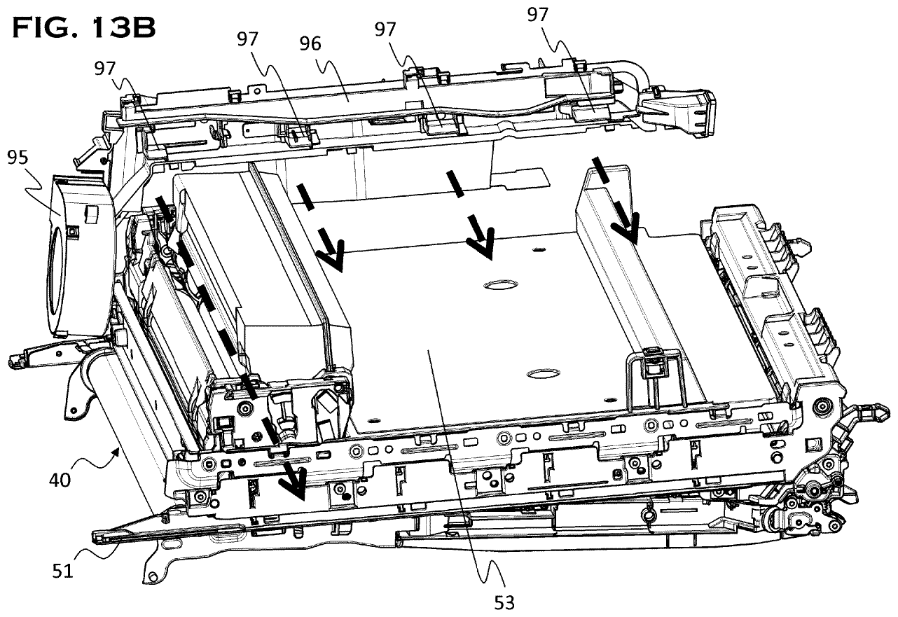

FIGS. 13A and 13B show the flow of air (airflow) near the tray unit by the dashed arrows. FIG. 13A shows the airflow in the tray unit 50c of the color printer 101, and FIG. 13B shows the airflow in the tray unit 50 of the monochrome printer 1.

In the color printer 101, a fan 95 serving as a blower member generates airflow. The airflow generated by the fan 95 passes through a main body duct 96 and is blown toward the cartridges PY, PM, PC, and PK from four exhaust openings 97 of the main body duct. The airflow then flows, as indicated by the dashed arrows, from one end (the far side in FIG. 13A) to the other end (the near side in FIG. 13A) in the roller rotation axis directions of the cartridges PY, PM, PC, and PK, and is discharged to the outside of the apparatus main body from the other end. Such an airflow is used to cool the cartridges PY, PM, PC, and PK.

Meanwhile, the monochrome printer 1 does not have the cartridges PY, PM, and PC. Therefore, if there is no tray cover 53, the air that has cooled the cartridges PY, PM, and PC will be blown to the transfer unit 40. Since the belt 41 of the transfer unit 40 expands and contracts depending on temperature, there is a concern that image quality may deteriorate if a large temperature difference exists in the roller rotational axis direction. Therefore, as in the present embodiment, the tray cover 53 is provided to cover the opening of the rear frame 58, so that cooling air can be prevented from blowing onto the belt 41.

Here, the cartridge P has the photosensitive drum 61, and when the cartridge is mounted, the photosensitive drum 61 is configured to face the primary transfer roller 42 located in the belt 41 of the transfer unit 40. With such a configuration, when the tray unit 50 is at the housed position TPS, the tray cover 53 is overlapped on the belt 41 and the mounting portion 55g2 is also overlapped on the belt 41 when viewed in the direction in which the cartridge P is mounted to the mounting portion 55g2. With such a configuration, the above-described advantageous effect of preventing the cooling air from blowing onto the belt 41 can be obtained.

### Pressing and Positioning Arrangement

With reference to FIGS. 10A, 10B, 14A, 14B, 15A, and 15B, the pressing structure (pressing structure on the main body side and pressed structure on the tray side) of the cartridge P and the tray cover 53, and a positioning structure for the cartridge in the monochrome printer 1 and the color printer 101 will be described.

As shown in FIG. 10A, the tray 51 of the printer 1 has the tray side plates 54 (54a and 54b), the front frame 52 held and fixed between the tray side plates 54a and 54b, the tray cover 53, and the rear frame 58. The tray side plate 54b is provided with a positioning structure 90 for the cartridge P, the structure being recessed upward in the direction of gravity V. The positioning structures 90 provided on the tray side plates 54a and 54b respectively serve as first and second support portions that support the cartridge P. The tray cover 53 also has tray pressing-receiving structures 93 (93a and 93b) provided on the left and right sides.

As shown in FIG. 10B, the tray 51c of the color printer 101 has the tray side plates 54c (54ca, 54cb) and the front frame 52 and the rear frame 58 which are held and fixed between the tray side plates 54ca and 54cb. The tray side plate 54cb is provided with positioning structures 90 corresponding to the cartridges PK to PY, each formed as a recess opening upward in the direction of gravity V.

FIG. 14A is a side view of the periphery of the tray 51 of the apparatus main body 1A of the printer 1, showing the tray 51 and a pressing member 92 (92a) provided on the apparatus main body side. FIG. 14B is a cross-sectional view taken along line A-A in FIG. 14A. The pressing member 92 includes a spring or other pressing means and is capable of pressing the pressing-receiving portion downward. The pressing direction of the pressing member 92 crosses the moving direction of the tray 51 and may be orthogonal thereto.

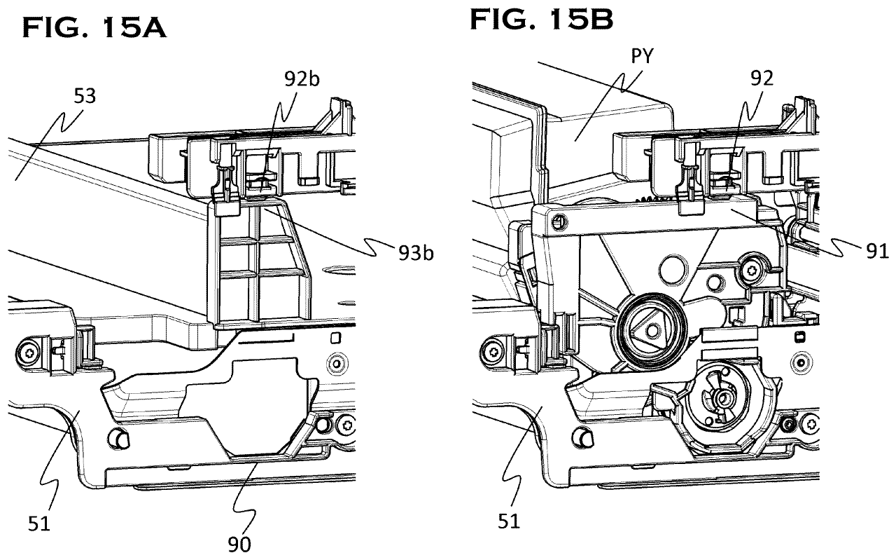

FIG. 15A is a perspective view of the pressing member 92 (92b) of the apparatus main body 1A of the monochrome printer 1 and the tray pressing-receiving structure 93 (93b) of the tray cover 53. FIG. 15B is a perspective view of the pressing member 92cb of the apparatus main body 1A of the color printer 101 and the cartridge pressing-receiving structure 91 (91b) of the cartridge P.

Here, the cartridge P mounted on the color printer 101 has cartridge pressing-receiving structures 91 (91a and 91b) to be pressed by pressing members 92c (92ca and 92cb) of the apparatus main body 1A. The pressing-receiving structures 91 are provided at both ends in the roller rotation axis direction (the longitudinal direction of the cartridge P). The pressing member 92c is positioned to press the cartridge P toward the positioning structure 90. The pressing member 92c presses the cartridge P toward the positioning structure 90 to position the cartridge P with respect to the tray 51c.

In addition, the tray cover 53 of the monochrome printer 1 is provided with a tray pressing-receiving structure 93 at a position corresponding to the position where the cartridge pressing-receiving structure 91c is located when the cartridge P is mounted in the color printer 101. As shown in FIG. 14A, the tray cover 53 is provided with tray cover positioning portions 94, which are positioned relative to the tray side plate 54. In the present embodiment, the tray cover 53 is positioned on the tray side plate 54 at the tray cover positioning portions 94. In the present embodiment, two tray cover positioning portions 94 are provided for each of the tray side plates 54a and 54b.

In the configuration described above, in the color printer 101, the four cartridges PY, PM, PC, and PK are subjected to a pressing force in a direction toward the tray 51c. Therefore, the pressing force is evenly applied to the color tray unit 50c with respect to the tray removal direction Dd1.

Meanwhile, in the tray unit 50 of the monochrome printer 1, a pressing force is applied from the pressing member 92 to the tray pressing-receiving structure 93 of the black cartridge PK and the tray cover 53. Since the tray cover 53 has a shape identical to the pressing-receiving structure 91 of the cartridge P, the pressing force can be evenly applied in the tray removal direction Dd1. Also, the cartridge PK to be mounted on the black station of the monochrome printer 1 is pressed toward the positioning structure 90, similarly to the cartridges of the color printer 101. Specifically, a black pressing member 98 (98a) is provided above the intended mounting position (PK) of the cartridge PK, and presses the mounted cartridge PK in the mounting direction. Similarly to the case of the color printer 101, the black pressing members 98 are also provided at both ends in the longitudinal direction of the cartridge PK.

Although the tray pressing-receiving structure 93 in the first embodiment is formed only at a position corresponding to the yellow station, the same tray pressing-receiving structure 93 may be formed at a position corresponding to the cyan station or at a position corresponding to the magenta station. Alternatively, the tray pressing-receiving structures 93 may be formed in a plurality of stations. From the viewpoint of reducing imbalance in the pressing force applied to the tray unit 50 in the horizontal direction H, it is preferable to distribute the region in which the black station is provided and the regions in which the tray pressing-receiving structures 93 are provided in the tray removal direction Dd1.

In addition, the tray pressing-receiving structure 93 may have a different shape from the pressing-receiving structure 91 of the cartridge P. For example, in the monochrome printer 1 according to the present embodiment, the pressing force applied from the tray pressing-receiving structures 93 of the tray cover 53 to the tray 51 is smaller than that applied to the tray 51c of the color printer 101, because the weight of the cartridge P is not applied. Therefore, the amount of protrusion of the tray pressing-receiving structures 93 in the direction of gravity V may be made greater than the amount of protrusion of the pressing-receiving structures 91 of the cartridge P, so that a larger pressing force is applied to the tray 51 of the printer 1. With such a configuration, a pressing force that takes into account the weight of the cartridge P can be imparted to the monochrome tray 51, thereby enabling the pressing force applied to the tray unit 50 to be optimized.

### Second Embodiment

A second embodiment will be described. Description of the same components as those of the first embodiment will not be provided. An exemplary structure for guiding airflow according to the embodiment will be described.

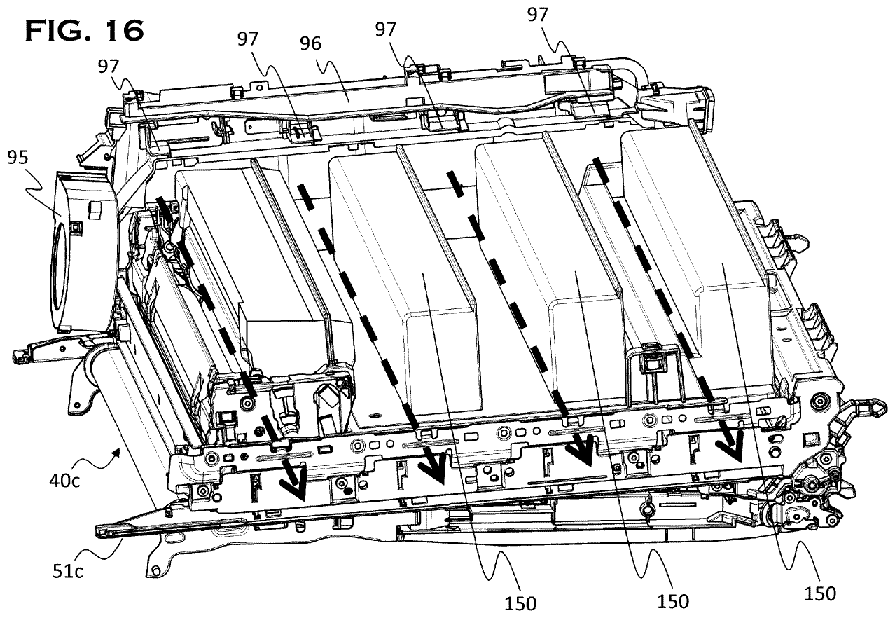

FIG. 16 is a view of the tray cover 53 of the printer 1 according to the second embodiment. The tray cover 53 is provided with a tray cover guide 150 at each of the positions corresponding to the housings of the yellow cartridge PY, the magenta cartridge PM, and the cyan cartridge PC in the color printer 101. The tray cover guide 150 may be formed integrally with the tray cover 53 or may be attached to the tray cover.

According to the configuration of the present embodiment, the advantageous effect of the first embodiment, namely, the prevention of airflow from blowing onto the surface of the belt 41 by the tray cover 53 covering the belt, can be retained. In addition, since the tray cover guides 150 function as restriction structures that restrict the airflow, an exhaust path similar to that in the color printer 101 can be formed, thereby preventing a decrease in exhaust efficiency.

### Third Embodiment

A third embodiment will be described. Descriptions of the same components as those in the first and second embodiments will not be provided. Another example of a duct shape for guiding airflow according to the present embodiment will be described.

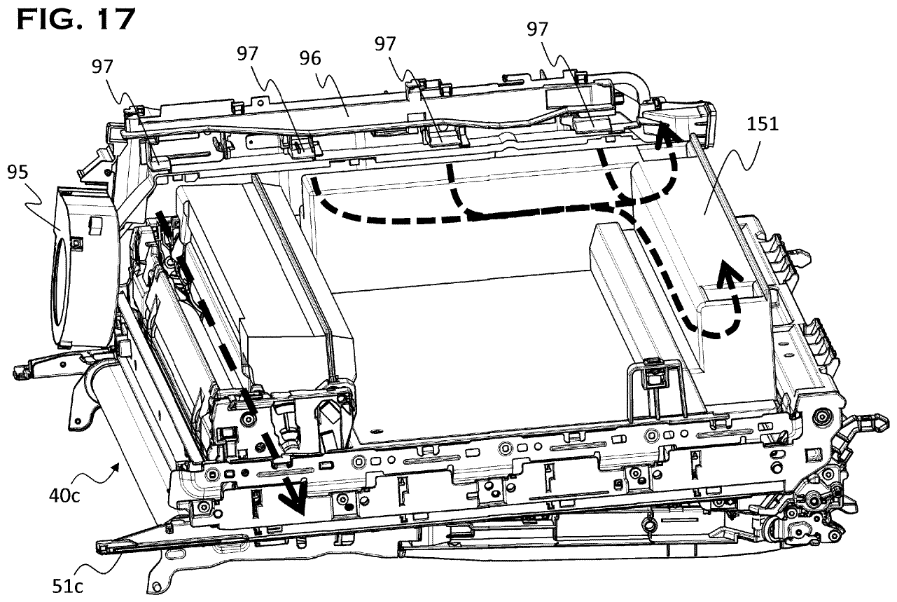

FIG. 17 is a view of the tray cover 53 in the monochrome printer 1 of the third embodiment. A tray duct 151 is formed on the upper surface of the tray cover 53. The tray duct 151 guides the cooling airflow, which is blown toward the yellow, magenta, and cyan stations in the color printer 101, to the fixing apparatus 80 and the paper discharge path 1d. This prevents air from being blown onto the surface of the belt and also allows the apparatus main body 1A to be cooled more effectively.

In the third embodiment, the outlet of the tray duct 151 is guided toward the fixing apparatus 80 and the paper discharge path 1d, but it may alternatively be guided toward the direction of the black cartridge PK, for example. Alternatively, the tray duct 151 may be shaped to cool other units.

### Fourth Embodiment

A fourth embodiment will be described. Descriptions of the same components as those in the first to third embodiments will not be provided. Another exemplary mounting portion 55g3 provided to the tray cover 53 according to the fourth embodiment will be described.

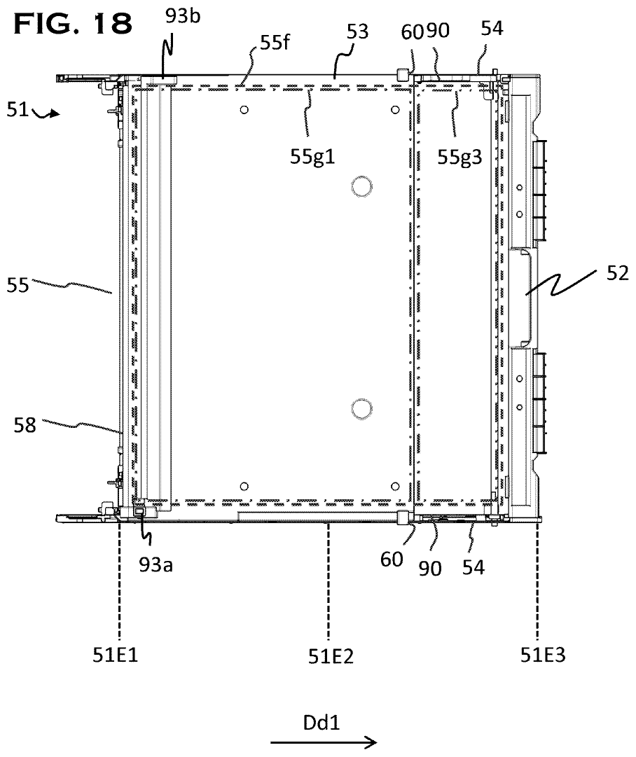

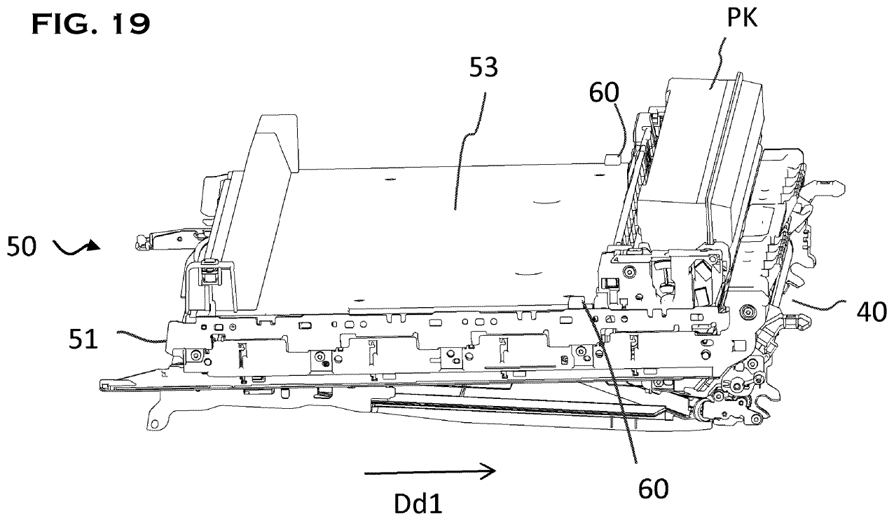

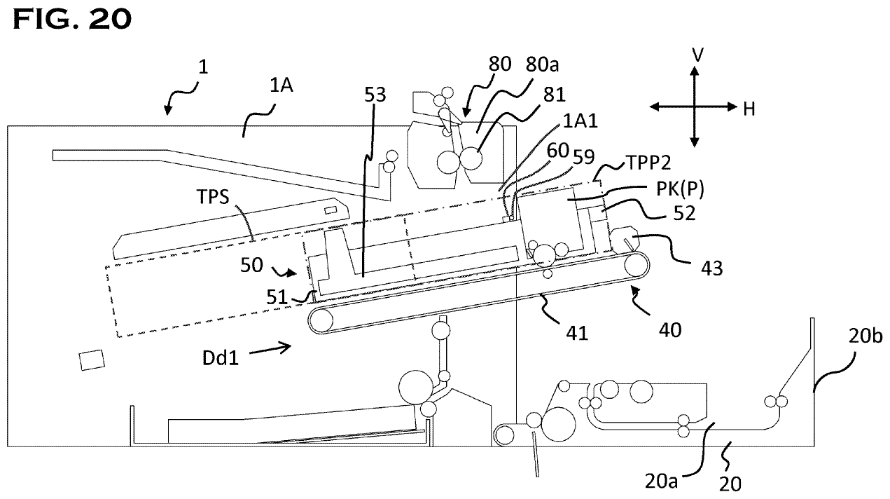

FIG. 18 is a view of the tray cover 53 according to the fourth embodiment. FIG. 19 is a view of the tray 51 of the tray unit 50 according to the fourth embodiment, with the black cartridge PK mounted thereon. FIG. 20 is a view of the tray unit 50 according to the fourth embodiment, moved to the pulled-out position TPP2.

In order to remove the black cartridge PK from the mounting portion 55g3, it is desirable to pull out the tray unit 50 to a position where no component of the printer 1 is located above the mounting portion 55g3 in the direction of gravity. That is, to make the black cartridge PK removable from the tray unit 50, the mounting portion 55g3 preferably protrudes outward beyond the outer contour of the apparatus main body 1A (i.e., beyond the outer peripheral surface of the apparatus main body 1A when the door 20 is closed). Meanwhile, it is also desirable to minimize the amount of movement required when the tray unit 50 is moved from the housed position TPS to the pulled-out position TPP2 (see FIG. 20). If the amount of movement of the tray unit 50 is small, the time required for the tray unit 50 to move from the housed position TPS to the pulled-out position TPP2 can be reduced compared to when the amount of movement is large. That is, the usability in replacing the black cartridge PK can be improved.

Accordingly, in the fourth embodiment, the mounting portion 55g3 is provided on the downstream side in the tray removal direction Dd1. More specifically, the tray 51 includes an upstream end 51E1, a downstream end 51E3, and a central portion 51E2 located midway between the upstream end 51E1 and the downstream end 51E3 in the tray removal direction Dd1. The central portion 51E2 is equidistant from the upstream end 51E1 and the downstream end 51E3. In the tray removal direction Dd1, the mounting portion 55g3 is located closer to the downstream end 51E3 than to the upstream end 51E1. Since the black cartridge PK is mounted on the mounting portion 55g3, the black cartridge PK is also positioned on the downstream side in the tray removal direction Dd1. By providing the mounting portion 55g3 on the downstream side in this way in the tray removal direction Dd1, the amount of movement of the tray unit 50 from the housed position TPS to the pulled-out position TPP2 can be reduced during mounting/removal of the black cartridge PK, compared to the case where the mounting portion is provided on the upstream side. In the present embodiment, when the tray unit 50 (tray 51) is in the pulled-out position TPP2, a part of the tray 51 protrudes outside beyond the apparatus main body 1A. At least an intermediate portion of the tray 51 is housed inside the apparatus main body 1A. According to the configuration of this embodiment, the amount of protrusion of the tray 51 from the apparatus main body 1A can be reduced. Accordingly, the working space for replacing the black cartridge PK can be reduced.

When the tray 51 is moved to the pulled-out position TPP2, a restriction portion 59 provided on the apparatus main body 1A comes into contact with a restriction target portion 60 provided on the tray 51, thereby restricting further movement of the tray 51 in the tray removal direction Dd1. In this restricted state, the restriction portion 59 and the restriction target portion 60 are provided such that the mounting portion 55g3 protrudes outward beyond the apparatus main body 1A. More specifically, in the restricted state, a part of the tray 51 protrudes outward beyond the outer peripheral surface of the apparatus main body 1A, while another part of the tray 51 remains inside the outer peripheral surface of the apparatus main body 1A. With the movement of the tray unit 50 thus limited, the user can recognize that the tray has been pulled out enough to allow removal of the black cartridge PK, thereby improving usability.

In order to further enhance the effect of reducing the amount of movement of the tray, it is preferable to position the mounting portion 55g3 at the most downstream end in the tray removal direction Dd1, as in the fourth embodiment. However, the position of the mounting portion 55g3 is not limited to the most downstream end. For example, the mounting portion 55g3 for the black cartridge PK may be located at a position corresponding to the magenta cartridge PM or the cyan cartridge PC in the color printer 101, as shown in FIG. 6. Even with such a configuration, the effect of reducing the amount of movement of the tray unit 50 can be provided, as compared to positioning the mounting portion 55g3 for the black cartridge PK at the most upstream side in the tray removal direction Dd1. That is, it is preferable to provide the mounting portion 55g3 at a position other than the most upstream end of the tray 51 in the tray removal direction Dd1. More preferably, the mounting portion 55g3 may be provided downstream of the central portion 51E2 of the tray 51 in the tray removal direction Dd1.

### Modifications

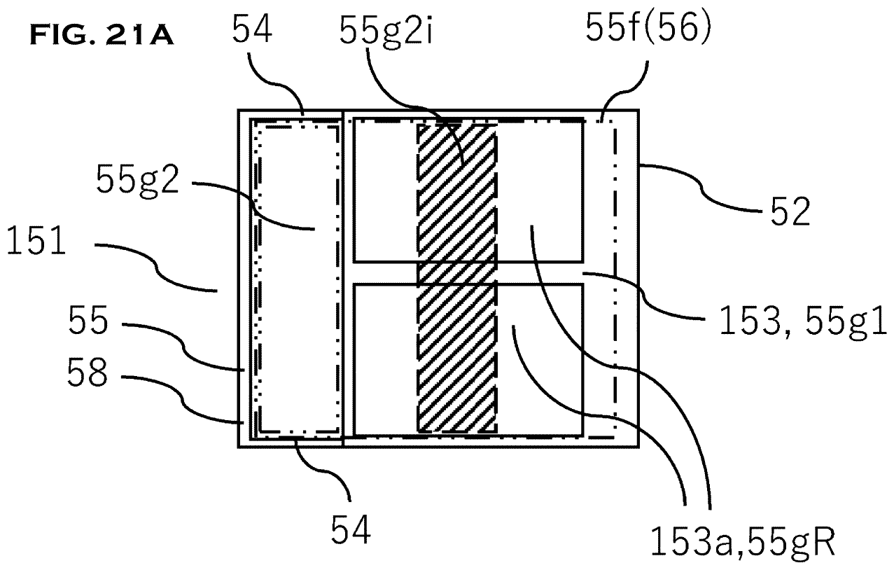

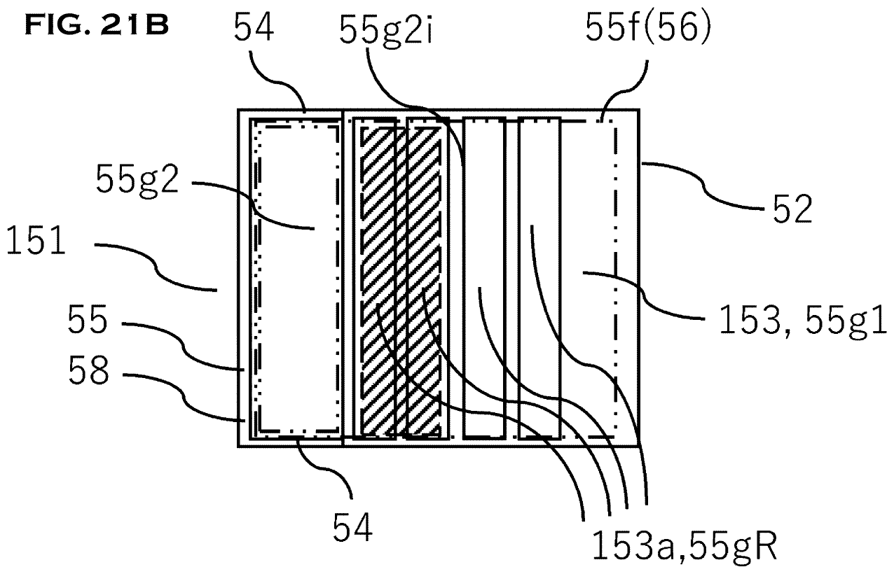

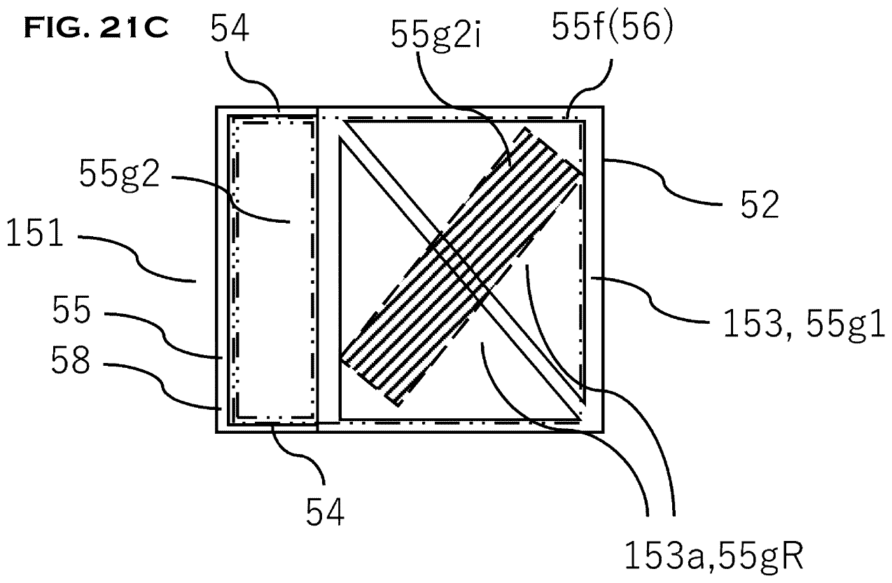

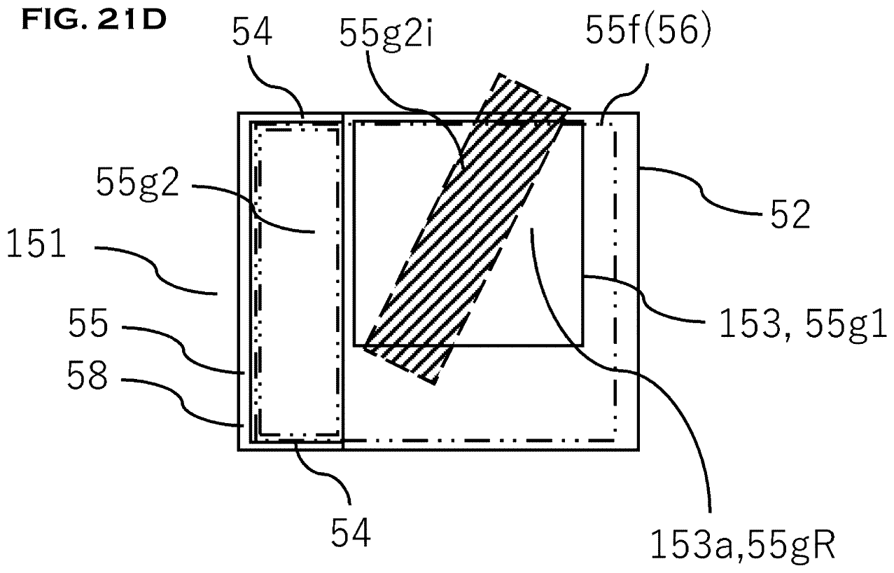

Modifications of the tray cover 53 will be described with reference to FIGS. 21A, 21B, 21C, and 21D. FIGS. 21A, 21B, 21C, and 21D are top views of the tray 151 of the printer 1 according to the modifications. FIGS. 21A, 21B, 21C, and 21D can be regarded as views of the tray 151 in the mounting direction when the cartridge P is mounted on the tray 151. The same reference numerals designate the same components as those of the preceding embodiments, and detailed descriptions thereof will not be provided.

The tray 151 of a printer (monochrome printer) 1 according to the modifications includes a tray cover 153. Although the shape of the tray cover 153 is different among FIGS. 21A, 21B, 21C, and 21D, the function of the tray cover 153 is the same. Note that the tray 151 may have a tray pressing-receiving structure 93.

In each of the modifications, the tray cover 153 covers a part of the region 55f (opening 56). As a result, a covered region 55g1, which is a region of the region 55f covered with the tray cover 153, is formed. A region of the region 55f that is not covered with the tray cover 153 constitutes a mounting portion 55g2. Furthermore, the region 55f includes a remaining region 55gR that is not covered with the tray cover 153. The remaining region 55gR can be defined as the region of the region 55f excluding the covered region 55g1 and the mounting portion 55g2.

More specifically, the tray covers 153 in the modifications each include at least one exposure opening 153a. A part of the region 55f (opening 56) is exposed through the exposure opening 153a.

Since mounting of the cartridge P to the remaining region 55gR is restricted, the user can easily identify the mounting portion 55g2. In other words, each remaining region 55gR need only have a shape that restricts the mounting of the cartridge P. Stated differently, when viewed in the direction in which the cartridge P is mounted toward the mounting portion 55g2, the remaining region 55gR does not allow a space having the same shape as the mounting portion 55g2 to be secured.

Hereinafter, a virtual region having the same shape as the mounting portion 55g2 when viewed in the mounting direction of the cartridge P to the mounting portion 55g2 will be referred to as a virtual region 55g2i. The virtual region 55g2i is indicated by hatching in FIGS. 21A, 21B, 21C, and 21D.

The tray cover 153 shown in FIG. 21A has a portion extending from the front frame 52 toward the rear frame 58. The tray cover 153 shown in FIG. 21A also includes a plurality of exposure openings 153a. While the tray cover 153 is fixed to the tray frame 55, a portion of the region 55f not covered with the tray cover 153 includes the remaining region 55gR. In FIG. 21A, the remaining region 55gR includes a plurality of regions spaced apart from each other.

In FIG. 21A, when the virtual region 55g2i is overlapped on the remaining region 55gR in the mounting direction of the cartridge P to the mounting portion 55g2, the size of the overlapping region between the virtual region 55g2i and the remaining region 55gR is maximized. In FIG. 21A, a part of the virtual region 55g2i is outside the remaining region 55gR. In other words, insertion of the cartridge P into the remaining region 55gR is restricted if attempted.

The tray cover 153 shown in FIG. 21B includes a plurality of portions extending from one tray side plate 54 toward the other tray side plate 54. The tray cover 153 shown in FIG. 21B includes a plurality of exposure openings 153a. In a state in which the tray cover 153 is fixed to the tray frame 55, a region of the region 55f not covered with the tray cover 153 includes a remaining region 55gR. In FIG. 21B, the remaining region 55gR includes a plurality of regions separated from each other.

In FIG. 21B, as viewed in the mounting direction of the cartridge P to the mounting portion 55g2, when the virtual region 55g2i is overlapped on the remaining region 55gR, the size of the overlapping region between the virtual region 55g2i and the remaining region 55gR is maximized. In FIG. 21B, a part of the virtual region 55g2i is outside the remaining region 55gR. In other words, insertion of the cartridge P into the remaining region 55gR is restricted if attempted.

The tray cover 153 shown in FIG. 21C has a portion extending from one tray side plate 54 toward the other tray side plate 54, and also extending from the front frame 52 toward the rear frame 58. The tray cover 153 shown in FIG. 21C includes a plurality of exposure openings 153a. In a state where the tray cover 153 is fixed to the tray frame 55, the region of the region 55f that is not covered with the tray cover 153 includes a remaining region 55gR. In FIG. 21C, the remaining region 55gR includes a plurality of regions separated from each other.

In FIG. 21C, as viewed in the mounting direction of the cartridge P to the mounting portion 55g2, when the virtual region 55g2i is overlapped on the remaining region 55gR, the size of the overlapping region between the virtual region 55g2i and the remaining region 55gR is maximized. In FIG. 21C, a part of the virtual region 55g2i is located outside the remaining region 55gR. In other words, insertion of the cartridge P into the remaining region 55gR is restricted if attempted.

The tray cover 153 shown in FIG. 21D includes one opening 153a. In a state where the tray cover 153 is fixed to the tray frame 55, the region of the region 55f not covered with the tray cover 153 includes a remaining region 55gR.

In FIG. 21D, as viewed in the mounting direction of the cartridge P to the mounting portion 55g2, when the virtual region 55g2i is overlapped on the remaining region 55gR, the size of the overlapping region between the virtual region 55g2i and the remaining region 55gR is maximized. In FIG. 21D, a part of the virtual region 55g2i is outside the remaining region 55gR. In other words, insertion of the cartridge P into the remaining region 55gR is restricted if attempted.

Here, as shown in FIGS. 21A, 21B, 21C and 21D, it can be considered that when the size of the overlapping region is maximized, a part of the virtual region 55g2i overlaps at least one of the tray cover 153 and the tray frame 55.

It should be noted that the shapes of the tray covers 153 shown in FIGS. 21A, 21B, 21C and 21D are merely examples of the tray covers 153 according to the modifications. That is, as long as securing a space in the remaining region 55gR having the same shape as the mounting portion 55g2 is restricted, the shape of the tray cover 153 can be modified as appropriate.

As described above, the configurations of the modifications allow the user to more easily identify the correct cartridge mounting portion.

According to the present disclosure, in an image forming apparatus having a tray that moves between inside and outside of the apparatus main body and allowing a cartridge to be removably mounted, the usability in cartridge mounting can be improved.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-167104, filed Sep. 26, 2024, Japanese Patent Application No. 2025-016335, filed Feb. 3, 2025, and, Japanese Patent Application No. 2025-109682, filed Jun. 27, 2025, which are hereby incorporated by reference herein in their entirety.

What is claimed is:

1. A monochrome printer to which a cartridge is to be removably mounted comprising:
an apparatus main body; and
a tray to which the cartridge is to be removably mounted and being movable between a housed position in which the tray is housed in an internal space of the apparatus main body and a pulled-out position in which the tray is pulled out from the apparatus main body, the tray including a frame having an opening and a cover fixed to the frame, wherein
the cover covers a part of the opening,
a region of the opening not covered with the cover forms a mounting portion in which the cartridge is contained, and
in a case that a region of the opening covered with the cover is defined as a covered region, the covered region is larger than the mounting portion when viewed in a direction in which the cartridge is mounted to the tray.

2. The monochrome printer according to claim 1, wherein the covered region has a size at least twice that of the mounting portion when viewed in the mounting direction.

3. The monochrome printer according to claim 1, wherein the frame comprises:
a first side wall having a first support portion configured to support the cartridge;
a second side wall opposed to the first side wall with respect to an opposing direction and having a second support portion configured to support the cartridge;
a first connection portion connected to the first and second side walls; and
a second connection portion connected to the first and second side walls, and
the opening is positioned between the first side wall and the second side wall, and between the first connection portion and second connection portion.

4. The monochrome printer according to claim 3, wherein
the mounting portion is positioned between the first connection portion and the cover when viewed in the mounting direction.

5. The monochrome printer according to claim 3, wherein the cover is fixed to the first side wall and the second side wall.

6. The monochrome printer according to claim 4, wherein the cover is fixed to the first side wall with a fastening member.

7. The monochrome printer according to claim 1, wherein the cover is positioned downstream of the mounting portion with respect to a pulled-out direction in which the tray is moved from the housed position to the pulled-out position.

8. The monochrome printer according to claim 1, wherein the cartridge has a photosensitive drum,
the monochrome printer further comprising a transfer device comprising a belt in contact with the photosensitive drum, and
the cover overlaps the belt and the mounting portion overlaps the belt as viewed in the mounting direction, when the tray is in the housed position.

9. The monochrome printer according to claim 1, wherein the apparatus main body has a pressing member configured to press a pressing-receiving portion provided on the cover in a direction crossing a direction in which the tray is moved, when the tray is in the housed position.

10. The monochrome printer according to claim 1, wherein the cover has a display portion configured to display information related to mounting of the cartridge to the tray.

11. The monochrome printer according to claim 1, further comprising a blower member configured to send air into the apparatus main body, wherein
the cover is provided with a restriction structure configured to restrict a flow of the air.

12. The monochrome printer according to claim 1, wherein the tray has a downstream end and an upstream end in a pull-out direction from the housed position to the pulled-out position, and
the mounting portion is closer to the downstream end than the upstream end in the pull-out direction, 13. The monochrome printer according to claim 12, wherein when the mounting portion is moved to a position that allows the cartridge to be removed from the mounting portion, a restriction portion provided on the apparatus main body and a restriction target portion provided on the tray come into contact with each other to restrict movement of the tray.

14. An image forming apparatus to which a cartridge is to be removably mounted comprising:
an apparatus main body; and
a tray to which the cartridge is to be removably mounted and being movable between a housed position in which the tray is housed in an internal space of the apparatus main body and a pulled-out position in which the tray is pulled out from the apparatus main body, the tray including a frame having an opening and a cover fixed to the frame by screws, wherein
the cover covers a part of the opening,
a region of the opening not covered with the cover forms a mounting portion in which the cartridge is contained,
in a case that a region of the opening covered with the cover is defined as a covered region, the covered region is larger than the mounting portion when viewed in a direction in which the cartridge is mounted to the tray.

15. A monochrome printer to which a cartridge is to be removably mounted comprising:
an apparatus main body; and
a tray to which the cartridge is to be removably mounted and being movable between a housed position in which the tray is housed in an internal space of the apparatus main body and a pulled-out position in which the tray is pulled out from the apparatus main body, the tray including a frame having an opening and a cover fixed to the frame, wherein
the cover covers a part of the opening,
a part of a region of the opening not covered with the cover forms a mounting portion in which the cartridge is contained, and
in a case that a region of the opening covered with the cover is defined as a covered region and a region obtained by removing the covered region and the mounting portion from the opening is defined as a remaining region when viewed in a direction in which the cartridge is mounted to the tray, when a virtual region having the same shape as the mounting portion is overlapped on the remaining region and the size of an overlapping region between the virtual region and the remaining region is maximized, a part of the virtual region is positioned outside the remaining region.
